(19) United States
(12) Patent Application Publication
(10) Pub. No.: US 2019/0373353 A1
(43) Pub. Date: Dec. 5, 2019

(54) EARPHONE FOR CHARGING TRANSMISSION THROUGH EARPHONE METAL HEADBAND

(71) Applicant: Innovation Sound Technology Co., Ltd., Shenzhen (CN)

(72) Inventors: Shun Ming Yuen, Shenzhen (CN); Wai Yin Mung, Shenzhen (CN); Ka Ming Wu, Shenzhen (CN)

(21) Appl. No.: 16/540,050

(22) Filed: Aug. 13, 2019

Related U.S. Application Data
(63) Continuation-in-part of application No. PCT/CN2018/102320, filed on Aug. 24, 2018.

(30) Foreign Application Priority Data
Feb. 12, 2018 (CN) 201820253467.0

(51) Int. Cl. H04R 1/10; H04R 5/033; H02J 7/00; H02J 7/02; H02J 50/10

(52) U.S. Cl. CPC H04R 1/1025; H04R 1/1008; H02J 50/10; H02J 7/0042; H02J 7/025; H04R 5/033

(57) ABSTRACT

The present invention discloses an earphone for charging transmission through an earphone metal headband. One end of a housing is connected with a connecting plate; a metal headband is fixed into the housing; one end of the metal headband is welded with a metal bracket; the other end of the metal bracket is welded to a PCB; the PCB is fixed into a shell; a loudspeaker is arranged in the shell; a wireless charging coil is fixed into the housing; and the wireless charging coil of the housing is electrically connected with a battery inside the housing through the PCB. The present invention is designed on the housing of the earphone; the metal bracket is used for transmitting current for charging. Because the current is transmitted through the metal bracket, the metal bracket becomes a part of the appearance, thereby avoiding reduction of charging input power caused by voltage decrease.

### CROSS REFERENCE TO RELATED APPLICATIONS

The present application is a Continuation-In-Part Application of PCT Application No. PCT/CN2018/102320 filed on Aug. 24, 2018, which claims the benefit of Chinese Patent Application No. 201820253467.0 filed on Feb. 12, 2018. All the above are hereby incorporated by reference.

### TECHNICAL FIELD

The present invention specifically relates to an earphone for charging transmission through an earphone metal headband, and belongs to the technical field of earphones.

### BACKGROUND

At present, wired earphones or wireless earphones on the market are generally passive. During use, a power supply needs to be additionally connected, which is inconvenient to use. The existing active electronic products are charged by connecting a power socket through a power line, so as to realize charging. However, such wired charging mode has many disadvantages. Since there are various different types of interface of the power line, many power sockets matched with the interface of the power line need to be installed to facilitate the charging of the earphone. That is to say, the wired charging mode of the traditional earphone has low versatility, and since many power sockets matched with the interface of the power line need to be installed, the construction cost and the construction difficulty are increased. In addition, there may be a problem of poor contact between the power line and the power socket, which causes that the earphone cannot be charged normally. At the same time, wired charging is conducted through the power line, which is inconvenient to use and carry and not conducive to saving user time and improving working efficiency.

### SUMMARY

To solve the technical problems to overcome the existing defects, the present invention provides an earphone for charging transmission through an earphone metal headband. A wireless charging coil or a solar panel is designed on a housing of the earphone; and a metal bracket is used for transmitting current for charging. Because the current is transmitted through the metal bracket, the metal bracket becomes a part of the appearance, thereby avoiding reduction of charging input power caused by decrease in voltage, thereby effectively solving the problems in the background.

To solve the above technical problems, the present invention provides the following technical solution:

The present invention provides an earphone for charging transmission through an earphone metal headband, wherein one end of the housing is connected with a connecting plate; a metal headband is fixed into the housing; one end of the metal headband is welded with a metal bracket; the other end of the metal bracket is welded to a PCB; the PCB is fixed into a shell; a loudspeaker is also arranged in the shell; a wireless charging coil is fixed into the housing; and the wireless charging coil of the housing is electrically connected with a battery inside the housing through the PCB. The battery is used for transmitting current for charging through the metal brackets on the left side and the right side; the metal bracket on each side is provided with two metal supporting strips; and the two metal supporting strips are respectively used as positive and negative electrodes for charging current input.

As a preferred technical solution of the present invention, the earphone further comprises a wireless charging frame; the housing is put on an upper part of the wireless charging frame; and the wireless charging frame is used for sensing with the wireless charging coil.

As a preferred technical solution of the present invention, a solar panel is used to replace the wireless charging coil.

As a preferred technical solution of the present invention, the solar panel is electrically connected with the battery through the PCB.

As a preferred technical solution of the present invention, the solar panel is fixed to an outer surface layer of the housing.

As a preferred technical solution of the present invention, an upper part of the metal brackets is made of a plated or rubberized outer casing.

The present invention achieves the beneficial effects: in the earphone for charging transmission through an earphone metal headband, the wireless charging coil or the solar panel is designed on the housing of the earphone; and the metal brackets are used for transmitting current for charging. Because the current is transmitted through the metal brackets, the metal brackets become a part of the appearance, thereby avoiding reduction of charging input power caused by decrease in voltage.

### DESCRIPTION OF DRAWINGS

The drawings are used to provide further understanding for the present invention and constitute part of the description. The drawings are used to explain the present invention together with the embodiments of the present invention, and do not constitute a limitation to the present invention.

In the figures:

FIG. 1 is an overall structural schematic diagram of an earphone for charging transmission through an earphone metal headband in an embodiment of the present invention.

FIG. 2 is a schematic diagram of a connecting plate of an earphone for charging transmission through an earphone metal headband in an embodiment of the present invention.

FIG. 3 is a structural schematic diagram of wireless charging of an earphone for charging transmission through an earphone metal headband in an embodiment of the present invention.

FIG. 4 is a schematic diagram of charging of a housing which is put on a wireless charging frame in an earphone for charging transmission through an earphone metal headband in an embodiment of the present invention.

FIG. 5 is a schematic diagram of distribution of a solar panel of an earphone for charging transmission through an earphone metal headband in an embodiment of the present invention.

FIG. 6 is a schematic diagram of charging of a solar panel of an earphone for charging transmission through an earphone metal headband in an embodiment of the present invention.

Numerals in the figures: 1 metal bracket; 2 shell; 3 loudspeaker; 4 housing; 5 PCB; 6 connecting plate; 7 wireless charging frame; 8 wireless charging coil; 9 battery; and 10 solar panel.

### DETAILED DESCRIPTION

The preferred embodiment of the present invention will be described below in combination with the drawings. It should be understood that the preferred embodiment described herein is only used for describing and explaining the present invention, but is not used for limiting the present invention.

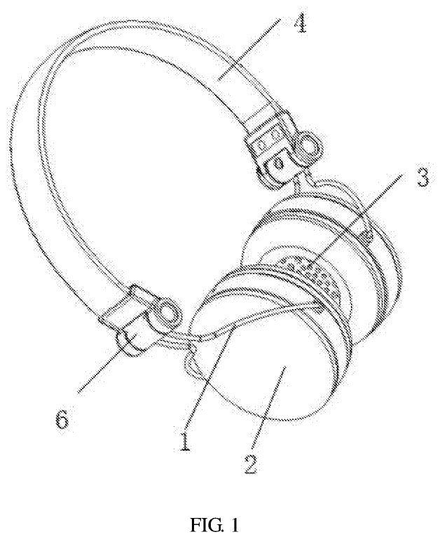

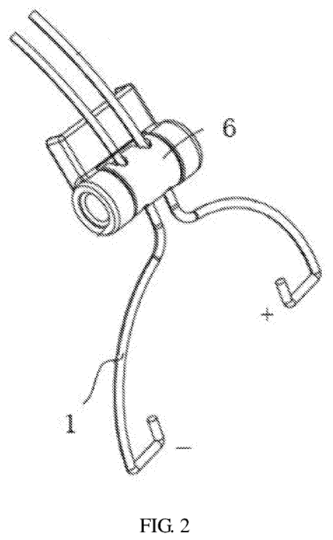

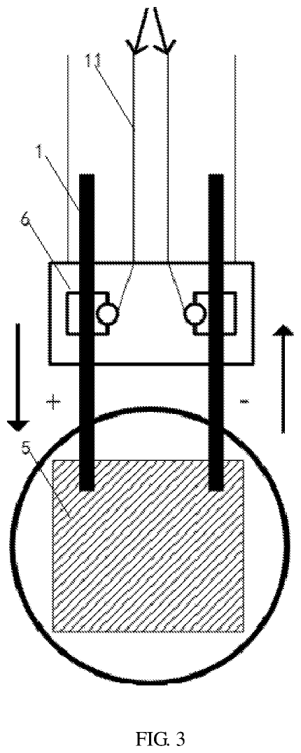

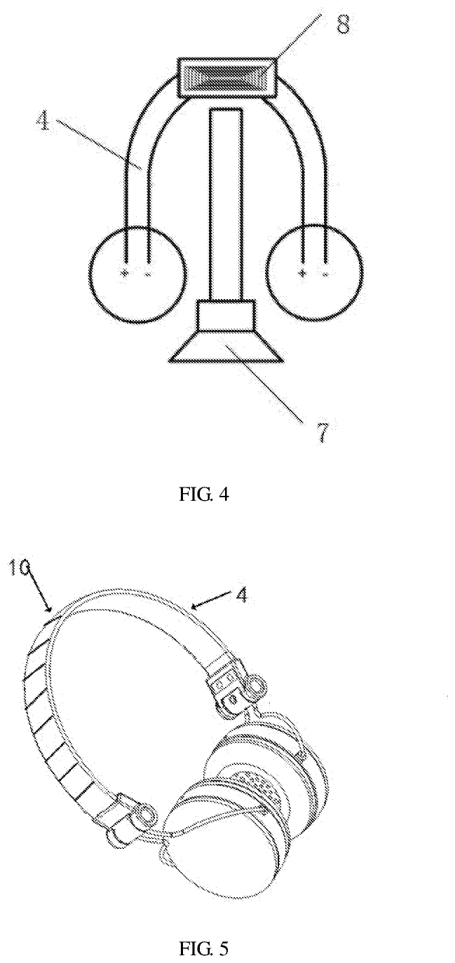

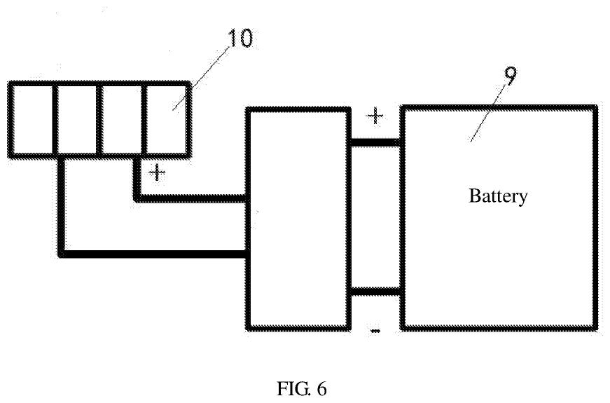

Embodiment: with reference to FIGS. 1-6, in an earphone for charging transmission through an earphone metal headband of the present invention, one end of a housing 4 is connected with a connecting plate 6; a metal headband 11 is fixed into the housing 4; one end of the metal headband 11 is welded with a metal bracket 1; the other end of the metal bracket 1 is welded to a PCB 5; the PCB 5 is fixed into a shell 2; a loudspeaker 3 is also arranged in the shell 2; a wireless charging coil 8 is fixed into the housing 4; and the wireless charging coil 8 of the housing 4 is electrically connected with a battery 9 inside the housing 4 through the PCB 5. The battery 9 is used for transmitting current for charging through the metal brackets 1 on the left side and the right side; the metal bracket 1 on each side is provided with two metal supporting strips; and the two metal supporting strips are respectively used as positive and negative electrodes for charging current input.

Further, the earphone also comprises a wireless charging frame 7; the housing 4 is put on an upper part of the wireless charging frame 7; and the wireless charging frame 7 is used for sensing with the wireless charging coil 8.

Further, a solar panel 10 is used to replace the wireless charging coil 8.

Further, the solar panel 10 is electrically connected with the battery 9 through the PCB 5.

Further, the solar panel 10 is fixed to an outer surface layer of the housing 4.

Further, an upper part of the metal brackets 1 is made of a plated or rubberized outer casing, to provide insulating function.

It should be indicated that in the earphone for charging transmission through an earphone metal headband in the present invention, the wireless charging coil or the solar panel is designed on the housing of the earphone during work; and the metal brackets are used for transmitting current for charging. Because the current is transmitted through the metal brackets, the metal brackets become a part of the appearance, thereby avoiding reduction of charging input power caused by decrease in voltage.

Finally, it should be noted that the above description is only a preferred embodiment of the present invention, and is not intended to limit the present invention. Although the present invention is described in detail with reference to the above embodiment, those skilled in the art may still modify the technical solution recorded in the above embodiment, or equivalently replace some of the technical features. Any modification, equivalent replacement, improvement, etc. made within the spirit and the principle of the present invention shall be included within the protection scope of the present invention.

What is claimed is:

1. An earphone for charging transmission through an earphone metal headband, wherein one end of a housing (4) is connected with a connecting plate (6); a metal headband (11) is fixed into the housing (4); one end of the metal headband (11) is welded with a metal bracket (1); the other end of the metal bracket (1) is welded to a PCB (5); the PCB (5) is fixed into a shell (2); a loudspeaker (3) is also arranged in the shell (2); a wireless charging coil (8) is fixed into the housing (4); and the wireless charging coil (8) of the housing (4) is electrically connected with a battery (9) inside the housing (4) through the PCB (5), characterized in that the battery (9) is used for transmitting current for charging through the metal brackets (1) on the left side and the right side; the metal bracket (1) on each side is provided with two metal supporting strips; and the two metal supporting strips are respectively used as positive and negative electrodes for charging current input.

2. The earphone for charging transmission through an earphone metal headband according to claim 1, characterized in that the earphone further comprises a wireless charging frame (7); the housing (4) is put on an upper part of the wireless charging frame (7); and the wireless charging frame (7) is used for sensing with the wireless charging coil (8).

3. The earphone for charging transmission through an earphone metal headband according to claim 1, characterized in that a solar panel (10) is used to replace the wireless charging coil (8).

4. The earphone for charging transmission through an earphone metal headband according to claim 3, characterized in that the solar panel (10) is electrically connected with the battery (9) through the PCB (5).

5. The earphone for charging transmission through an earphone metal headband according to claim 3, characterized in that the solar panel (10) is fixed to an outer surface layer of the housing (4).

6. The earphone for charging transmission through an earphone metal headband according to claim 1, characterized in that an upper part of the metal brackets (1) is made of a plated or rubberized outer casing.
